(19) United States
(12) Patent Application Publication
(10) Pub. No.: US 2021/0282549 A1
(43) Pub. Date: Sep. 16, 2021

(54) Lockable Recipe Organizer Box

(71) Applicant: Minh Lu, San Jose, CA (US)

(72) Inventor: Minh Lu, San Jose, CA (US)

(21) Appl. No.: 16/816,275

(22) Filed: Mar. 12, 2020

(51) Int. Cl. A47B 23/06; B65D 55/14; B65D 25/20

(52) U.S. Cl. CPC A47B 23/06; B65D 25/20; B65D 55/14

(57) ABSTRACT

The present invention relates to a recipe card holder and retrieval box, and more particularly to box for holding recipe cards, and for use as such in the kitchen and also to hold mobile phone with a locking system.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### Field of the Invention

The present invention relates generally to recipe box with cards and divider and phone holder lockable recipe organizer box.

### Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

This invention relates generally to recipe box and more particularly, but not by way of limitation, to a recipe card lockable storage box.

Heretofore cabinets, tables and desks include drawers with drawer pulls used to hold tickets, labels and recipe cards. One type drawer uses a clip mounted to the bottom of the drawer. The recipe is attached to the clip and viewed when the drawer is pulled out from the cabinet.

There are also drawers that have clips attached to the drawer pull for clipping tickets, labels, or recipes thereon.

Certain locking devices exist to address this problem; however, they tend to be bulky, contain lots of parts or buttons, and limiting on accessibility into a container when unlocked. A need therefore exists for a time-lockable device to help assist with self-control, that is easy to use, allows for maximum access into the container, and is not bulky.

None of the prior art methods have been found to be completely suitable to meet these needs and are cumbersome. The present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, and abstract as a whole.

In order to solve the above problems, the present invention is to provide a novel and convenient and durable box with spaces to hold cards, preferably recipe cards, having means for holding the cards in storage position, in a satisfactory manner, and having also means for holding phone, when in use, in position to be conveniently used or to keep it safe.

Another embodiment of the present invention is that the invention is a decorative wooden box that is Lockable to maintain the security feature, and can be made from any material such as solid pine.

Another object is to provide a space to hold two card slots and a phone holder slot on the top of the box.

Briefly, it is Designed and built for keeping precious recipes dry and organized, this well-constructed, beautiful box fits all your recipe cards, tabs, and dividers into grooves of the box.

It is another object of the invention to provide storage for recipe cards that can be quickly removed, displayed in the front of the drawer for easy viewing and then returned to the drawer for later use.

It is also an object to provide certain details and features of construction, tending to increase the general efficiency of a card index box of this particular character.

The present application provides a lockable storage system for storing items in a box.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 is an exemplary front view of the invention.

FIG. 200 is an inside view of the invention.

FIG. 300 shows environmental view of the invention.

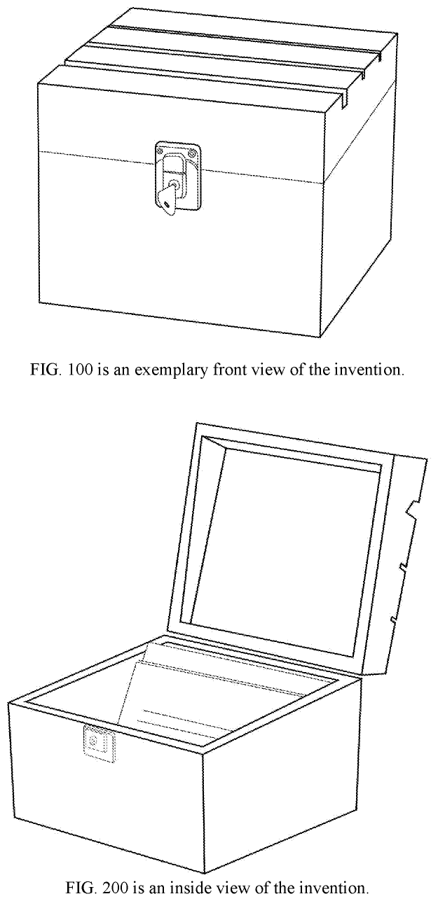

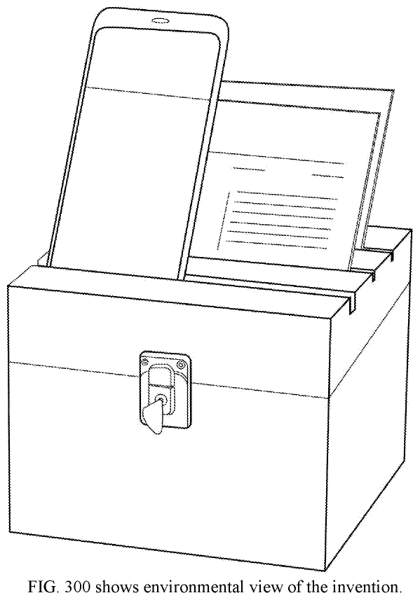

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

Unless otherwise defined, all terms (including technical and scientific terms) used herein have the same meaning as commonly understood by one having an ordinary skill in the art to which the invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques are disclosed. Each of these has individual benefit and each can also be used in conjunction with one or more, or in some cases all, of the other disclosed techniques. Accordingly, for the sake of clarity, this description will refrain from repeating possible combination in an unnecessary fashion. Nevertheless, the specifications and claim/s should be read with the understanding that such combinations are entirely within the scope of the invention and the claim/s.

The method of the present invention relates to a recipe box with cards and divider and phone holder which lockable recipe organizer box to provide storage for recipe cards that can be quickly removed, displayed in the front of the drawer for easy viewing inside the grooves and then returned to the drawer for later use. The top grooves helps so that the card is held in place for displaying the recipe card when using the recipe in cooking or baking.

Another embodiment of the present invention is to view the card in which the bottom edge of the recipe card is inserted in the groove on the top of the box for easy viewing.

The use of the invention is simple and inexpensive, and practically add nothing to the cost of manufacture of the box or cabinet, and are effective and satisfactory for the purpose.

Briefly stated, a plurality of recipe cards, for example, can be positioned upright on the grooves of the box and the box moved in the direction to support the upright view of the cards easily. In the box can be stored recipe cards such that the box serves the dual purpose of holding the recipe card for easy retrieval.

The box can also be used to keep cellphone in one of the groove of the box.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1) A recipe card storage device for displaying recipe cards and storing them therein comprising:
a. A rectangular wooden box;
b. On the top there are two grooves to hold recipe cards;
c. On the top there is one groove to hold to mobile phone, ipad or tablet;
d. Inside the box it can hold variety of cards or items;
e. The box is lockable to avoid un-necessary access.

2) The invention involves the cut out of the lid in order to hold a phone or ipad/tablet upright.

3) The invention works by placing the recipe card upright for easy view of the card on the grooves.
